(19) United States
(12) Patent Application Publication
(10) Pub. No.: US 2006/0251876 A1
(43) Pub. Date: Nov. 9, 2006

(54) Sealable, multilayer, coextruded packaging film, its use and process for its production

(75) Inventors: Wolfram Goerlitz, Wiesbaden (DE); Stammatis Ginossatis, Koropi-Attiki (GR)

Correspondence Address: CONNOLLY BOVE LODGE & HUTZ, LLP, P O BOX 2207, WILMINGTON, DE, 19899, US

(73) Assignee: TICONA GmbH, Kelsterbach (DE)

(21) Appl. No.: 10/555,619

(22) PCT Filed: May 4, 2004
(86) PCT No.: PCT/EP04/04694

§ 371 Date: Feb. 20, 2006

(30) Foreign Application Priority Data
May 7, 2003 (EP) 03010233.9

(51) Int. Cl. B32B 27/36; B32B 27/32; B65D 83/04; B32B 27/08

(52) U.S. Cl. 428/220; 428/523; 428/354; 428/483; 428/476.3; 428/447; 206/531; 264/173.19

(57) ABSTRACT

The invention relates to a sealable, multilayer, coextruded packaging film with high transparency and high tensile strength. The film is composed of at least one core layer A made from a polyolefin with high tensile strength together with low elongation, and of outer layers B and C arranged on the two sides. The core layer A comprises from 50 to 100 % by weight of cyclic olefin polymer (COC) having a T_{g} of at least 60 ° C. The outer layers B and C may comprise at least one sealable polymer and one functional polymer. Intermediate layers may be arranged between layer A and layers B and C improving adhesion between layers. This film has a total thickness in the range from 20 to 200 μm, the core layer A making up from 5 to 60% of the total thickness of the film. The film is used in “flow-pack” packages produced on form-fill seal machines, or as a cover film on thermoformed blister packages or on cups (lidding).

The invention relates to a sealable, multilayer, coextruded packaging film having low elongation under mechanical load combined with high transparency, suitable for application in “flow-pack” packages produced on form-fill-seal machines, or as a cover film on thermoformed blister packages or on cups (lidding).

The film of this invention comprises at least three layers, between each of which additional primer layers can be arranged if needed, in particular a core layer A comprising a polyolefin, having high modulus or low elongation under load, and outer layers B and C arranged on the two sides of the core layer A, these being identical or different and composed of sealable polyolefins (polyethylene, polypropylene) or of polymers having functional properties. The film of the invention has exceptionally good mechanical properties, i.e. low elongation under mechanical load. The invention also relates to a cost-effective process for producing said film, and to its use as a carrier for high-quality print, and to the production of flow-pack packages on form-fill-seal machines.

Films used for foodstuffs packaging must have special properties in relation to their processability on packaging machines, their printability, and their barrier properties with respect to atmospheric gases such as oxygen, and with respect to water vapor. For reasons of good multicolor printability and processability on packaging machines, the need is for films with-high modulus, low coefficient friction, and good sealability.

This combination of features is usually not achievable using a single homopolymer or polymer blends, since no single polymer material possessing all these properties is available. The prior art proposes various multilayer film structures to solve said problem, in particular stretch-oriented films or laminates of stretch-oriented films with unoriented sealant films.

Good-quality multicolor printability requires low elongation in the printing press and little dimensional change in the film. In addition, residual solvent content in the printing ink needs to be low for food packaging applications. It is therefore desirable to use elevated temperatures for efficient drying of the ink. The specific manufacturing process for biaxially oriented films typically gives them the required high modulus, i.e. low elongation under load, and good dimensional stability at elevated temperatures, and these films are widely used as carriers for high-quality multicolor print. However, these films cannot in themselves provide the required sealing properties needed for conversion into packaging on industrial form-fill-seal machines. Laminates of this printed film with a second, non-oriented film are therefore typically used, where the second film contributes additional functional properties as needed, i.e. superior sealing properties or an additional barrier to moisture and gases.

The prior art films have a number of disadvantages. Production of laminated films as described above involves an undesirable multistep film production process with orientation and subsequent lamination to a second film. These laminated asymmetric film structures can curl, causing additional problems when packages are made from precut panels.

It is therefore desirable to provide a film which is suitable for high-quality multicolor printing and processing on high-speed packaging machines, and which can advantageously be manufactured in a one-step process by multilayer coextrusion without any need for orientation or lamination to a second film. While coextruded multilayer films are prior art and are widely used for less demanding applications, they have disadvantages for the intended application, due to lack of mechanical strength, and mostly have disadvantageous tear properties, due to high elongation of these films combined with low mechanical strength.

It is therefore an object of the present invention to provide a novel multilayer packaging film with high suitability for use on form-fill-seal machines to produce flow-pack packages or lidding with high-quality multicolor printing. This object has been achieved by producing a film in a conventional multilayer coextrusion process, and incorporating an amorphous cycloolefin copolymer (COC) into the multilayer film structure.

The invention therefore provides a multilayer film comprising a core layer A comprising an amount of from 50 to 100% by weight, based on the total weight of the core layer A, of an amorphous cycloolefin copolymer (COC) which has a glass transition temperature T_{g} of at least 60° C., and comprising at least two outer layers B and C on the two sides of the core layer A, one of which comprises at least one sealable polymer, and one of which comprises at least one functional polymer, where between the core layer A and the outer layers B and C may be arranged additional intermediate layers bringing about firm bonding between the core layer A and the outer layers B and C, and where the film has a total thickness in the range from 10 to 200 μm, preferably from 20 to 150 μm, wherein the core layer A makes up from 5 to 60% of the total thickness of the film, preferably from 10 to 50%, particularly preferred from 15 to 40%.

The invention also provides a process for the production of this film, and the use of the film for the production of flow-pack packaging on form-fill-seal machines, or as a cover film on thermoformed blister packs or on cups.

The cycloolefin copolymer (COC) used in the invention preferably has a glass transition temperature T_{g} of more than 60° C., preferably from about 80 to 150° C.

The cycloolefin copolymers (COC) used for the core layer A of the multilayer film of the invention are generally composed of ethylene units and/or of units comprising an alpha-olefin with a cyclic, bicyclic or multicyclic olefin. Preferably, the COC is a copolymer from ethylene and norbornene. Such COC are prepared in the presence of transition metal polymerization catalysts described in EP-A-0 407 870 or EP-A-0 485 893. The processes described there are suitable to provide COC with low polydispersity (M_{w}/Mₙ=2). This avoids disadvantages such as migration, extractability or tack caused by the low-molecular-weight constituents. The molecular weight of the COC is adjusted during the preparation process by using hydrogen, careful catalyst selection, and careful selection of the conditions of the polymerization reaction.

Outer layers having functional properties in the sense of the invention comprise polymers which further improve the good barrier properties of COC in terms of the moisture vapor transmission rate or polymers which comprise additives improving the frictional properties of the film. Examples of these additives are anti-blocking agents, such as inorganic particles made from alkaline earth metal carbonates or from alkali metal carbonates, or from oxides, or from silicates.

Other mineral additives are materials such as aluminum oxide, aluminum sulfate, barium sulfate, calcium carbonate, magnesium carbonate, silicates, such as aluminum silicate (kaolin), and magnesium silicate (talc), silicon dioxide and titanium dioxide.

Besides the inorganic additives, however, it is possible and advantageous to use organic lubricants, such as polydialkylsiloxanes of various composition.

According to the invention, the polymers used having functional properties may comprise polyamides, produced from the reaction of diamines with dicarboxylic acids or by ring-opening of lactams. Examples of suitable polyamides are polyhexamethylenesebacamide and poly-epsilon-caprolactam. Other polymers with functional properties are polyvinyl alcohols with varying degrees of hydrolysis, and polyesters, such as polybutylene terephthalate.

According to the invention, suitable sealable layers are layers made from polyolefins, in particular from PE, or from copolymers of ethylene and propylene having a propylene content of up to 10% by weight. Other suitable sealable polymers are ionomeres such as ®Surlyn 1705 from DuPont.

Besides the core layer A and the outer layers B and C, the films of the invention may comprise other layers, if this is a requirement for the technical application in the packaging of certain packed goods. The additional layers here should, as far as necessary, also have been bonded securely to the other layers of the film, using adhesion promoter layers.

The combination of various polymers in a composite according to the instant invention, whereby the composite being prepared by the simple technique of coextrusion, combines the property profiles of the different polymeric materials with one another in a favorable manner. The layers of the film fit together to ensure that the film composite has the mechanical properties needed, specifically high tensile strength with low elongation, these being required for high-quality multicolor printing and further processing to give packaging, such as flow packs or lid films, while also providing the water-vapor barrier and gas barrier needed to preserve the contents, together with sealing properties. However, in addition to an improvement in properties a reduction in the cumulative thickness of the entire film structure is achieved, giving either higher mechanical strength at a given film thickness or a substantial rise in barrier action with respect to water vapor, or, for given property profiles, a marked reduction in layer thickness and, thus, a cost saving.

The film of the invention has a combination of the following properties:
High tensile elongation modulus measured according to ASTM D822 (i.e. high tensile stresses with low elongation);
good barrier properties with respect to water vapor according to DIN 53122 (i.e. low moisture vapor transmission rate);
good transparency and printability.

In terms of the instant invention, a high tensile elongation modulus is understood to be in the range of at least 500 N/mm², preferred at least 700 N/mm², most preferred at least 800 N/mm².

In terms of the instant invention, good barrier properties are understood to be in the range of below 0,5 g·mm/(m²-day), preferred below 0,35 g·mm/(m²-day).

One or more outer layers of the multilayer film of the invention may moreover also comprise neutralizing agents, stabilizers, lubricants, hydrocarbon resins, and/or antistats, or antifogging agents.

Stabilizers which may be used are the customary stabilizing compounds for ethylene polymers, for propylene polymers, and for other alpha-olefin polymers. The amount added of these is from 0.05 to 2.0% by weight. Particularly suitable materials are phenolic stabilizers, alkali metal stearates, alkaline earth metal stearates, and/or alkali metal carbonates, alkaline earth metal carbonates. Preference is given to an amount of from 0.1 to 0.6% by weight, preferably from 0.15 to 0.3% by weight, of phenolic stabilizers whose molar mass is more than 500 g/mol. Particularly advantageous materials are pentaerythritol tetrakis-3-(3,5-di-tert-butyl-4-hydroxyphenyl)propionate or 1,3,5-trimethyl-2,4,6-tris(3,5-di-tert-butyl-4-hydroxybenzyl)benzene.

Lubricants are higher aliphatic amides, higher aliphatic esters, and waxes and metal soaps, and also polydimethylsiloxanes. The effective amount of lubricant is in the range from 0.1 to 3.0% by weight. A particularly suitable method is addition of higher aliphatic amides in the range from 0.15 to 0.25% by weight in base layers and/or outer layers.

Preferred antistats are alkali metal alkanesulfonates, polyether-modified, i.e. ethoxylated and/or propoxylated, polydiorganosiloxanes (polydialkylsiloxanes, polyalkylphenylsiloxanes, and the like), and/or the substantially straight-chain and saturated aliphatic, tertiary amines having an aliphatic radical having from 10 to 20 carbon atoms, these having substitutions with α-hydroxy-(C₁-C₄)-alkyl groups, particularly suitable materials being N,N-bis(2-hydroxyethyl)alkylamines having from 10 to 20 carbon atoms, preferably from 12 to 18 carbon atoms, in the alkyl radical. The effective amount of antistat is in the range from 0.05 to 3.0% by weight. Glycerol monostearate is another preferred antistat.

Where appropriate, the covering also comprises organic compounds having polar and non-polar groups. Preferred organic compounds are alkanols and fatty acids having from 8 to 30 carbon atoms in the alkyl group, in particular fatty acids and primary n-alkanols having from 12 to 24 carbon atoms, and also polydiorganosiloxanes and/or polyorganohydrosiloxanes, such as polydimethyl-siloxane and polymethylhydrosiloxane.

Addition of sufficient amounts of these substances can also permit production of a white or opaque embodiment of the film.

Semicrystalline polyolefins which may generally be used are polymers of ethylene or α-olefins, such as propene, n-butene, isobutene, and higher α-olefins, or copolymers of these. Use may advantageously be made of polypropylene, polyethylenes such as HDPE, LDPE and LLDPE, or else of mixtures prepared from these. Preference is given to mixtures of LDPE and LLDPE in any mixing ratio from 5 to 100%. Where appropriate, the semicrystalline polyolefin comprises other additives, each in an effective amount.

The invention also provides a process for producing the film of the invention, in which all the polymers/polymer mixtures forming the film are melted in separate extruders, and then the melt(s) is/are coextruded through a flat-film or annular die, formed to a film, cooled and solidified in a cast or blown film process and, followed, where appropriate, only by surface treatment of the film, thereby omitting the stretching steps usually needed for high strength films.

The additives used where appropriate may be present in the polymer or polymer mixture as it stands, or may be added via masterbatch technology. The film is then wound up in the usual way, using wind-up equipment.

The take-off roll or take-off rolls which also cool(s) and solidify(ies) the extruded film are mostly maintained at a temperature from 20 to 90° C.

Where appropriate, one or both surfaces of the film may be corona- or flame-treated by one of the known methods, the usual result being an improvement in the surface polarity, and therefore the printability, of the treated surface.

The test methods used in the examples listed below were as follows:

| Tensile elongation modulus | | ASTM |
|---|---|---|
| | | D882 |
| Moisture Barrier properties | 38° C. at 90% | DIN |
| | rel. humidity | 53122 |

### WORKING EXAMPLES

Coextrusion was used to produce a number of multilayer films, using a flat-film die (example 1) in a cast film process, or using an annular die in a blown film process (examples 2 to 7). These films had total thickness of from 50 to 120 μm and comprised at least five layers, a base layer A and two outer layers B1/B2 and C1/C2, bonded to the base layer by two tie layers (primer layers). The thickness of each layer is shown in the table below.

The base layer A comprised thermoplastic COC having an amorphous structure based on ethylene and norbornene from Ticona GmbH, Germany, (®Topas 8007 and ®Topas 6015 with T_{g} of 80° C. and 160° C., respectively). The base layer in some of the samples also comprised a blend of COC with linear low density polyethylene (LLDPE).

The films were printed on a 6-color gravure printing machine.

These multilayer films were used to produce flow-pack packages on horizontal form-fill-seal machines (type: ULMA PV 350, Spain).

Films comprising laminated oriented outer layers B of polyester or polyamide and sealant layers C of polyethylene were used for comparison purposes as comparison examples 1 and 2.

The performance of all of the samples produced along with the working examples in the printing and packaging processes was comparable with or better than that of the films produced along with the comparative examples.

TABLE 1

| | | Layer | Total |
|---|---|---|---|
| | | Thickness | Thickness |
| Example | Layer structure | (μm) | (μm) |
| 1 | Structure 1; layer | 17/5/7/5/16 | 50 |
| | A = 7 μm COC | | |
| 2 | Structure 2; layer | 20/5/5/10/25 | 65 |
| | A = 10 μm | | |
| | COC/LLDPE blend (80:20) | | |
| 3 | Structure 2; layer | 20/5/5/10/25 | 65 |
| | A = 10 μm | | |
| | COC/LLDPE blend (90:10) | | |
| 4 | Structure 2; layer | 20/5/5/10/25 | 65 |
| | A = 10 μm COC | | |
| 5 | Structure 3; layer | 15/5/5/15/5/20 | 65 |
| | A = 15 μm COC | | |
| 6 | Structure 3; layer | 25/5/5/20/5/22 | 85 |
| | A = 20 μm COC | | |
| 7 | Structure 3; layer | 40/5/5/25/5/40 | 120 |
| | A = 25 μm COC | | |

TABLE 2
Structures

| | |
|---|---|
| Structure 1 | PA/Tie/COC/Tie/Ionomer |
| Where | COC has T_{g} of 160° C. (®Topas 6015, Ticona) |
| | PA is a PA6 (®Ultramid 35, BASF) |
| | Tie is an MAA-grafted polyolefin (®Bynel 41E623, |
| | DuPont) |
| | Ionomer (®Surlyn 1705, DuPont) |
| Structure 2 | PA/EVOH/Tie/COC/LLDPE |
| Where | COC has T_{g} of 80° C. (Topas 8007, Ticona) |
| | PA is a PA6 (Ultramid 35, BASF) |
| | EVOH is a 38% copolymer (H171 from EVALco) |
| | Tie is an MAA-grafted polyolefin (Bynel 41E623, |
| | DuPont) |
| | LLDPE has a density of 0.910 g/cm² (ExxonMobil |
| | 1012CA) |
| Structure 3 | PA/EVOH/Tie/COC/Ionomer |
| Where | COC has T_{g} of 80° C. (Topas 8007, Ticona) |
| | PA is a PA6 (Ultramid 35, BASF) |
| | EVOH is a 38% copolymer (H171 from EVALco) |
| | Tie is an MAA-grafted polyolefin (Bynel 41E623, |
| | DuPont) |
| | Ionomer (Surlyn 1705, DuPont) |

### COMPARATIVE EXAMPLES

The following comparative films were laminated, comprising an oriented film made from polyamide or polyester and a non-oriented film made from polyethylene:

TABLE 3
Comparative examples, laminates

| | | |
|---|---|---|
| 92 μm | oPET/PE | 12 μm oPET/80 μm PE |
| 85 μm | oPA/PE | 15 μm oPA/70 μm PE |

oPET means oriented polyethyleneterephthalate,

oPA means oriented polyamide.

| | |
|---|---|
| Tensile | ASTM D882 |
| elongation | |
| modulus: | |
| F1 | force in N at 1% elongation of 15 mm strip, setup |
| | according to ASTM D882, |
| MVTR | DIN 53122, at 38° C. and 90% rel. humidity. |
| | Results given as moisture vapor transmission rate |
| | of sample film in units of g/(m² · day) and for |
| | comparison purposes also calculated thickness |
| | independent permeability coefficients for water |
| | vapor in units of g · mm/(m² · day). |

The results from the examples and from the comparative examples are shown in Table 4 below:

TABLE 4

| | Modulus | Modulus | F1 | F1 | | MVTR |
|---|---|---|---|---|---|---|
| Property | Machine | Transverse | Machine | Transverse | MVTR | Permeability |
| Condition | direction | direction | direction | direction | Film | coefficient |
| Unit | N/mm² | N/mm² | N | N | g/(m² · day) | g · mm/(m² · day) |
| Example 1 | 710 | 570 | 5.3 | 4.3 | 9.3 | 0.47 |
| Example 2 | 841 | 856 | 8.6 | 8.8 | 5.7 | 0.37 |
| Example 3 | 877 | 919 | 8.7 | 9.1 | 5.5 | 0.36 |
| Example 4 | 1025 | 1016 | 10.5 | 10.4 | 5.3 | 0.34 |
| Example 5 | 1150 | 1123 | 11.7 | 11.4 | 4.0 | 0.26 |
| Example 6 | 1156 | 1181 | 14.7 | 15.0 | 3.1 | 0.26 |
| Example 7 | 994 | 925 | 17.9 | 16.7 | 2.4 | 0.29 |
| Comp. example 1 | 723 | 740 | 9.8 | 10.0 | 6.2 | 0.56 |
| Comp. example 2 | 420 | 440 | 5.4 | 5.7 | 7.0 | 0.60 |

Mechanical properties at elevated temperatures were evaluated by measuring storage modulus at temperature of 70° C. by DMA (dynamic mechanical analysis). Equipment: GABO Qualimeter EPLEXOR 150 N. Conditions: static strain=0,7%, dynamic strain=0.3%. Frequency: 10 Hz.

Results are shown in Table 5 below.

At a temperature of 70° C. all films prepared according to working examples of the instant invention had higher storage modulus than the films prepared along with comparative examples.

TABLE 5

| | | Storage Modulus |
|---|---|---|
| Sample | Temperature | N/mm² |
| Example 1 | 70° C. | 540 |
| Example 4 | 70° C. | 600 |
| Comp. Example 1 | 70° C. | 340 |

Film layer sequences of films according to the invention-are not limited to those given in the above examples. Additional examples of structures with 5 to 9 layers are exemplified in the following table below:

No. Layer Sequence
Example 8 PA/EVOH/tie/A(COC)/(tie)/sealant (PE, EVA.)
Example 9 PBT/tie/EVOH/tie/A(COC)/sealant (PE-LLD)
Example 10 PA/EVOH/tie/A(COC)/PE-LLD/tie/sealant (lonomer)
Example 11 LDPE/tie/EVOH/tie/A(COC)/PE-LLD/A(COC)/tie/sealant (lonomer)
Example 12 TB/tie/EVOH/tie/A(COC)/PE-LLD/TB
   Wherein:

A(COC) denotes the core layer A containing at least 50% of amorphous polyolefin. TB denotes additional layers comprising a blend of COC and Polyethylene (less than 30% of COC)

Examples 8 to 10 stand for examples for different functional outer layers (sealant and oxygen barrier);

Example 11 illustrates an example for a core layer split into two sublayers;

Example 12 illustrates an example for a low curl film containing additional outer layers comprising of a COC-blend.

1. A multilayer packaging film comprising a core layer A comprising an amount of from 50 to 100% by weight, based on the total weight of the core layer A, of an amorphous cycloolefin copolymer (COC) which has a glass transition temperature T_{g} of at least 60° C., and comprising at least two outer layers B and C on the two sides of the core layer A, one of which comprises at least one sealable polymer, and one of which comprises at least one functional polymer, where between the core layer A and the outer layers B and C may be arranged additional intermediate layers bringing about firm bonding between the core layer A and the outer layers B and C, and where the film has a total thickness in the range from 10 to 200 μm, wherein the core layer A makes up from 5 to 60% of the total thickness of the film.

2. The packaging film as claimed in claim 1, wherein the COC is a copolymer of ethylene and/or of an α-olefin with a cyclic, bicyclic, or multicyclic olefin.

3. The packaging film as claimed in 1, wherein the COC is a copolymer made from ethylene and norbornene.

4. The packaging film as claimed in claim 1, wherein the functional polymers comprise polymers further improving the barrier properties of COC in terms of gas transmission rate or polymers which comprise additives improving the frictional properties of the film.

5. The packaging film as claimed in claim 1, wherein the functional polymers comprise polyamides, produced from the reaction of diamines with dicarboxylic acids or by ring-opening of lactams, or other polymers with functional properties.

6. The packaging film as claimed in claim 1, wherein the additives comprise anti-blocking agents, or from oxides, or from silicates.

7. The packaging film as claimed in claim 1, wherein the functional polymers further comprise organic lubricants.

8. The packaging film as claimed in wherein the sealable polymers comprise polyolefins and vinylacetate or sealable ionomeres.

9. The packaging film as claimed in claim 1, wherein the intermediate layers comprise adhesion promoters, primer compositions or adhesives.

10. The packaging film as claimed in claim 1, wherein its tensile elongation modulus is in the range of at least 500 N/mm².

11. The packaging film as claimed in claim 1, wherein its moisture vapor transition rate normalised to 1 mm thickness is in the range of less than 0.5 g·mm/(m²·day).

12. A process for producing a sealable, multilayer packaging film as claimed in claim 1 wherein the polymer mixtures and polymers forming the layers of the film are melted in separate extruders and the melted polymers are coextruded through a flat-film die or a tubular die and the resultant coextruded film is drawn off on one or more rolls, whereupon it cools and solidifies, followed, optionally by surface treatment of the film, thereby omitting any stretching step.

13. The process as claimed in claim 12, wherein additives used are present in the polymer or polymer mixture as it stands, or are added via masterbatch technology.

14. (canceled)

15. (canceled)

16. The packaging film as claimed in 1, wherein the film has a total thickness in the range from 20 to 150 μm and the core layer A makes up from 10 to 50% of the total thickness of the film.

17. The packaging film as claimed in 1, wherein the core layer A makes up from 15 to 40% of the total thickness of the film and wherein the films tensile elongation modulus is in the range of at least 700 N/mm² and wherein the films moisture vapor transition rate normalized to 1 mm thickness is in the range of less than 0.35 g-mm/(m²·day).

18. The packaging film as claimed in claim 1, wherein the functional polymers comprise polyamides, produced from the reaction of diamines with dicarboxylic acids or polyhexamethylenesebacamide and poly-epsilon-caprolactam, or ethylene vinyl alcohol copolymers or polyvinyl alcohols with varying degrees of hydrolysis and polyethylene terephtalate or polybutylene terephthalate.

19. The packaging film as claimed in claim 1, wherein the additives comprise anti-blocking agents which are inorganic particles made from alkaline earth metal carbonates or from alkali metal carbonates, or from oxides, or from silicates.

20. The packaging film as claimed in claim 1, wherein the functional polymers further comprise polydialkylsiloxanes.

21. Flow-pack packages produced on form-fill-seal machines which comprises the packaging film as claimed in claim 1.

22. A cover film on thermoformed blister packages or on cups (lidding) which comprises the packaging film as claimed in claim 1.
